(19) United States
(12) Patent Application Publication
(10) Pub. No.: US 2014/0342227 A1
(43) Pub. Date: Nov. 20, 2014

(54) LITHIUM-SULPHUR CELL CATHODE WITH A LAYER SYSTEM

(71) Applicant: Robert Bosch GmbH, Stuttgart (DE)

(72) Inventors: Ulrich Hasenkox, Ditzingen (DE); Constanze Sorhage, Stuttgart (DE)

(21) Appl. No.: 14/363,966

(22) PCT Filed: Oct. 22, 2012
(86) PCT No.: PCT/EP2012/070865

§ 371 Date: Jun. 9, 2014

(30) Foreign Application Priority Data
Dec. 14, 2011 (DE) 10 2011 088 528.5

(51) Int. Cl. H01M 4/36; H01M 4/04; H01M 4/1397; H01M 4/136

(52) U.S. Cl. CPC H01M 4/366; H01M 4/136; H01M 4/0402; H01M 4/1397; H01M 4/0409; H01M 4/0419; H01M 2004/028
USPC 429/218.1; 427/58

(57) ABSTRACT

A cathode for a lithium-sulphur cell includes a current collector. A cathode layer system is applied to the current collector in order to achieve a high energy density, current rate and cycle stability. This layer system includes at least one conductive layer and at least one layer that contains sulphur. The at least one conductive layer is in electrical contact with the current collector.

The present invention relates to a cathode for a lithium-sulfur cell, to a production method, to lithium-sulfur cells and also to mobile or stationary systems, such as vehicles or energy storage installations.

### PRIOR ART

Compared to conventional lithium ion cells, lithium-sulfur batteries (Li—S batteries) afford the advantage of a considerably higher energy density. The lithium-sulfur system provides, with respect to the electrochemically active material, a theoretical energy density of 2600 Wh/kg, which is many times greater than the energy density of approximately 580 Wh/kg that can be achieved by conventional lithium ion technology.

A lithium-sulfur battery normally comprises a cathode comprising a current collector, for example a metal foil, and a coating applied to the current collector, the coating comprising a mixture of sulfur, an electrically conductive additive, usually carbon black, and a binder.

The document US 2002/0192557 describes a method for producing cathodes for lithium-sulfur cells, in which sulfur, an electrically conductive additive, in particular conductive carbon black, and a binder are ground to form a homogeneous, viscous mixture and then an aluminum foil is coated with the viscous mixture.

### DISCLOSURE OF THE INVENTION

The present invention relates to a cathode for a lithium-sulfur cell, which cathode comprises a current collector. An in particular multilayered cathode layer system comprising at least one conductive layer and at least one sulfur-containing layer is applied to the current collector. The conductive layer(s) makes or make electrical contact in particular with the current collector.

In this context, a conductive layer can be understood to mean in particular a layer which comprises or is at least substantially formed from at least one electrically conductive material.

In this context, an electrical contact connection between the current collector and a conductive layer can be understood to mean both a direct contact connection between the respective conductive layer and the current collector and also an indirect contact connection via one or more further conductive layers and electrically conductive layer portions which are arranged between the respective conductive layer and the current collector and make electrical contact with one another and also with the respective conductive layer and the current collector.

As a result of the application of a plurality of layers of differing composition as the cathode layer and the resultant multilayered structure of the cathode layer, it is possible to introduce a series of different functions into the cathode.

In this respect, the conductive layer(s) can ensure that the paths which have to be covered between the sulfur and the current collector can be shorter than in the case of a random distribution of sulfur particles and electrically conductive particles, particularly since, for example in the case of electrically conductive particles arranged in a random distribution, there does not necessarily have to be an electrical contact connection between the particles and additionally between the particles and the current collector, and if there is, the path which the current has to cover between the current collector and the electrochemically active material, sulfur, is generally longer than in the case of deliberately introduced conduit structures. The internal resistance can thus advantageously be lowered.

Large contact surfaces between the electrochemically active material, sulfur, and the electrically conductive matrix moreover make it possible to achieve high current rates.

In addition, a multilayered structure makes it possible to improve the cycle resistance, or cycle stability, that is to say the available capacity considered over numerous charging and discharging cycles; this is usually inadequate in the case of lithium-sulfur cells having conventional cathodes and at present prevents a technical prevalence of conventional lithium-sulfur cells. The improved cycle resistance and also better exploitation of sulfur can be achieved by the multilayered structure in particular by virtue of the fact that the layer-like structure makes it possible to prevent a loss of sulfur, for example as insoluble Li₂S₂ and Li₂S, which can be formed during discharging of the cell and with which electrochemical contact is no longer made during recharging of the cell in the case of conventional cathodes, or by the diffusion of soluble polysulfides, which in the case of conventional cathodes can diffuse at locations at which there is no longer any electrical contact.

Moreover, the conductive layer(s) and the sulfur-containing layer(s) can be optimized for the respective function. By way of example, since the mechanical stability and adhesion to the current collector can be ensured by the conductive layer(s), it is possible to dispense with a binder in the sulfur-containing layer(s) and to thereby increase the overall energy density. Since the conductive layer(s) can be configured in a targeted manner and in a manner optimized for the function, it is possible to minimize the material thereof and to thereby as a whole improve the material ratio between electrochemically active sulfur and electrically conductive material.

By virtue of the conductive layer(s) which are formed in a targeted manner for this purpose, it is moreover advantageously possible to largely avoid an interruption of electrically conductive paths and therefore a loss of cathode regions with which electrical contact is no longer made, as can arise in the case of conventional cathodes of lithium-sulfur cells in the case of changes in volume, in particular during cyclic operation.

Moreover, the mechanical stability and the electrical conductivity of the cathode can be increased by the conductive layer(s), this making it possible to provide the current collector with a thinner configuration and to thus increase the overall energy density and also to improve the weight ratio of current collector and cathode coating.

According to one embodiment, the cathode layer system comprises at least two conductive layers and at least two sulfur-containing layers. In particular, in this respect the conductive layers and sulfur-containing layers can be formed in alternation.

According to a further embodiment, a conductive layer of the cathode layer system is applied to the current collector. This makes it possible to dispense with a binder in the sulfur-containing layers and to thereby increase the energy density of the cathode.

According to a further embodiment, the sulfur-containing layers have a structuring.

In this context, a structuring can be understood to mean in particular a spatial configuration of different layer portions which is formed in a targeted manner. A spatial arrangement arising randomly, for example in a mixture, is in this context in particular not understood to mean a structuring.

Targeted structuring advantageously makes it possible to produce regions which are optimized for the function and which can serve, for example, for providing electrolytes or additives or for receiving reaction products. As a whole, targeted structuring makes it possible to achieve higher energy densities and also to increase the cycle resistance of the cells.

According to one configuration of this embodiment, a structured, sulfur-containing layer comprises a multiplicity of sulfur-containing layer portions and at least one electrically conductive layer portion, wherein the sulfur-containing layer portions are surrounded in each case at least partially by the at least one electrically conductive layer portion. As a result, it is advantageously possible for the sulfur-containing layer portions to be spatially separated from one another and for electrical contact to be made therewith in each case at the same time.

As a result of a reduction in the dimensions of the regions in which the electrochemically active sulfur is present, it is possible to shorten the paths between electrically conductive matrix and the electrically insulating sulfur and to better exploit the sulfur. As already mentioned, short paths moreover ensure low internal resistances, in which case large surface areas of the contacts between sulfur and electrically conductive matrix make high current rates possible.

According to a specific configuration, the sulfur-containing layer portions of a or the structured, sulfur-containing layer(s) are configured in the form of a repetitive pattern, and/or the at least one electrically conductive layer portion of a or the structured, sulfur-containing layer(s) has a reticular form.

According to a further specific configuration, the at least one electrically conductive layer portion of a structured, sulfur-containing layer has a honeycomb-like form, wherein the sulfur-containing layer portions of the structured, sulfur-containing layer are formed in each case in the internal spaces of the honeycomb.

In this context, honeycomb-like can be understood to mean not only a honeycomb structure based substantially on hexagons, as is known from bee honeycombs, but also honeycomb structures based substantially on one or more, symmetrical or asymmetrical, different polygonal shapes, such as triangles, quadrilaterals, pentagons, heptagons, octagons, etc., or a combination thereof with hexagons.

According to a further embodiment, at least one structured, sulfur-containing layer is arranged between two conductive layers. In particular in this respect the two conductive layers can cover or close off the sulfur-containing layer portions of the structured, sulfur-containing layer. In particular in this respect the sulfur-containing layer portions can be enclosed by the conductive layers and the electrically conductive layer portions of the structured, sulfur-containing layer. In this respect, it is possible both that the sulfur-containing layer portions are enclosed completely by the conductive layers and the electrically conductive layer portions and that the conductive layers and electrically conductive layer portions have pores or recesses which have been introduced therein in a targeted manner and which form ion transporting channels in a targeted manner.

The enclosure of the electrochemical sulfur in corresponding structures makes it possible to avoid diffusion of the polysulfides which are soluble in the electrolyte. As a result, the sulfur can also be retained as polysulfide in the vicinity of the electrically conductive matrix and can be re-oxidized during charging of the cell, as a result of which the sulfur is available again in the discharging operations which follow. The introduction of specific ion transporting channels can have the effect that the lithium ions required for charge equalization during discharging can diffuse into the sulfur-containing structures, but the soluble products which have formed cannot diffuse out of the sulfur-containing structures.

According to a further embodiment, the conductive layer(s) and/or the electrically conductive layer portion(s) of the structured, sulfur-containing layer(s) is or are formed from a porous material. It is thus advantageously possible to realize ion transporting channels in a targeted manner.

According to another alternative or additional embodiment, the conductive layer(s) and/or the electrically conductive layer portion(s) of the structured, sulfur-containing layer(s) has or have recesses which are introduced in a targeted manner. It is thus advantageously possible to realize ion transporting channels in a targeted manner.

According to a further embodiment, the conductive layer(s) and/or the electrically conductive layer portion(s) of the structured, sulfur-containing layer(s) comprises or comprise a metallic material, for example aluminum. In particular, the conductive layers and/or the electrically conductive layer portions can be formed therefrom. Metallic materials have a lower electrical resistivity than conductive carbon black, and therefore it is advantageously possible as a result for the internal resistance to be reduced and the current rate to be increased.

According to another alternative or additional embodiment, the conductive layer(s) and/or the electrically conductive layer portion(s) of the structured, sulfur-containing layer(s) comprises or comprise an electrically conductive material which conducts lithium ions, for example an inorganic lithium ion conductor or a polymer electrolyte. In particular, the conductive layers and/or the electrically conductive layer portions can be formed therefrom. An electrically conductive material which conducts lithium ions advantageously also makes it possible to further improve the ion transportation and as a result, in turn, the current rate.

According to a further embodiment, the conductive layer(s) is or are formed from a porous material. In particular, pores can form reticular channels in the porous material. This makes it possible to introduce ion transporting channels in a targeted manner.

According to another alternative or additional embodiment, the conductive layer(s) has or have recesses which are introduced in a targeted manner.

This affords a further possibility to introduce ion transporting channels in a targeted manner.

The sulfur-containing layer(s) can have in each case for example a layer thickness of ≦200 μm. By virtue of a small layer thickness of the regions in which the electrochemically active sulfur is present, the paths between electrically conductive matrix and electrically insulating sulfur can advantageously be shortened, such that the sulfur can be exploited to the greatest possible extent. As already mentioned, short paths ensure low internal resistances, in which case large surface areas of the contacts between sulfur and electrically conductive matrix make high current rates possible.

The conductive layer(s) can have in each case for example a layer thickness of ≦200 μm. To achieve high energy densities, preference is given in this case to the lowest possible value, for example of ≦20 μm, particularly advantageously ≦5 μm.

In particular, the conductive layer(s) can have a smaller layer thickness than the sulfur-containing layer(s). By way of example, the layer thickness of the conductive layer(s) can be 50%, for example 10%, of the layer thickness of the sulfur-containing layer(s).

The current collector can be, for example, an aluminum foil. The current collector can have a layer thickness of for example ≦50 μm. To achieve particularly high energy densities, preference is given to the lowest possible value, for example of ≦20 μm.

In particular, the conductive layer(s) can have a layer thickness which is smaller than the thickness of the current collector. By way of example, the layer thickness of the conductive layer(s) can be ≦50%, for example ≦10%, of the thickness of the current collector.

It is thus possible, for example, for a sulfur-containing layer having a layer thickness of 50 μm to be applied to a conductive layer having a layer thickness of for example 2 μm, and in particular, for this operation to be repeated several times. In this respect, the layer system makes it possible overall to provide more electrochemically utilizable sulfur than a conventional lithium-sulfur cell sulfur layer, the layer thickness and therefore sulfur content of which is limited, in particular for reasons relating to the electrical contact properties of the sulfur. Overall, it is thus advantageously possible to increase the mass of electrochemically utilizable sulfur, particularly with respect to that of the current collector. In this way, the overall energy density can in turn be increased. Moreover, since the layer system contributes to the mechanical stability, the current collector can be provided with a thinner configuration and therefore the overall energy density can be further increased.

With respect to further features and advantages of the cathode according to the invention, reference is hereby explicitly made to the explanations in conjunction with the method according to the invention as explained below, in conjunction with the lithium-sulfur cell according to the invention as explained below and in conjunction with the mobile or stationary system according to the invention as explained below and also to the figures and the description of the figures.

The present invention further relates to a method for producing a cathode for a lithium-sulfur cell, in particular for producing a cathode according to the invention, comprising the method steps of:

a) providing a current collector foil,

b) applying a conductive layer to the current collector foil, and

c) applying a sulfur-containing layer to the conductive layer.

According to one embodiment, the method furthermore comprises method step d): applying a further conductive layer to the sulfur-containing layer.

According to a further embodiment, the method furthermore comprises method step e): applying a further sulfur-containing layer to the further conductive layer.

In particular, it is possible to repeat method steps d) and e) several times in alternation (d′, e′, d″, e″, . . . ).

According to a further embodiment, method step c) and/or e) involves the application of a structured, sulfur-containing layer. The structured, sulfur-containing layer can in this case in particular comprise a multiplicity of sulfur-containing layer portions and at least one electrically conductive layer portion. In this respect, the sulfur-containing layer portions can in each case be at least substantially surrounded by the at least one electrically conductive layer portion and in particular can thereby be at least substantially spatially separated from one another.

Here, at least substantially can be understood to mean that specific ion channels can be provided.

In particular, method step c) and/or e) can involve the application of the structured, sulfur-containing layer in such a manner that firstly at least one electrically conductive layer portion of reticular configuration is applied, the interstices of the electrically conductive layer portion of reticular configuration then being filled with sulfur-containing material.

The conductive layers which are applied before and after the application of the structured, sulfur-containing layer—for example in method step b) and d) or d) and d′)—can be configured in particular in such a manner that electrically conductive layer portions of the conductive layers together with the at least one electrically conductive layer portion of the structured, sulfur-containing layer at least substantially or even entirely enclose the sulfur-containing layer portions.

According to a further embodiment, the conductive layer(s) and sulfur-containing layer(s) are applied by means of printing, doctor blade application and/or spraying.

With respect to further features and advantages of the method according to the invention, reference is hereby explicitly made to the explanations in conjunction with the cathode according to the invention, in conjunction with the lithium-sulfur cell according to the invention as explained below and in conjunction with the mobile or stationary system according to the invention as explained below and also to the figures and the description of the figures.

The present invention further relates to a lithium-sulfur cell comprising a cathode according to the invention or a cathode produced according to the invention.

The anode of the lithium-sulfur cell can comprise in particular metallic lithium. By way of example, the anode can comprise a current collector, for example made of copper, and a lithium foil applied thereto.

Furthermore, the lithium-sulfur cell can comprise an electrolyte, which makes the transportation of lithium ions possible.

Moreover, the lithium-sulfur cell can comprise a separator, which separates the anode and cathode chambers from one another and makes only the transportation of lithium ions possible.

With respect to further features and advantages of the lithium-sulfur cell according to the invention, reference is hereby explicitly made to the explanations in conjunction with the cathode according to the invention, in conjunction with the method according to the invention and in conjunction with the mobile or stationary system according to the invention as explained below and also to the figures and the description of the figures.

The present invention further relates to a mobile or stationary system comprising at least one lithium-sulfur cell according to the invention. In particular, this can be a vehicle, for example a hybrid vehicle, a plug-in hybrid vehicle or an electric vehicle, an energy storage installation, for example for stationary energy storage, for example in a house or a technical installation, an electric tool, an electric garden tool or an electronic device, for example a notebook, a PDA or a mobile telephone.

With respect to further features and advantages of the mobile or stationary system according to the invention, reference is hereby explicitly made to the explanations in conjunction with the cathode according to the invention, in conjunction with the method according to the invention and in conjunction with the lithium-sulfur cell according to the invention and also to the figures and the description of the figures.

### DRAWINGS AND EXAMPLES

Further advantages and advantageous configurations of the subjects according to the invention are illustrated by the drawings and will be explained in the description below. It is to be noted in this respect that the drawings have merely a descriptive character and are not intended to limit the invention in any way. In the drawings:

FIG. 1 shows a schematic cross section through a first embodiment of a cathode according to the invention;

FIG. 2 shows a schematic cross section through a second embodiment of a cathode according to the invention;

FIGS. 3a-5 show schematic cross sections and plan views for illustrating an embodiment of a method according to the invention for producing a third embodiment of a cathode according to the invention; and

FIG. 6 shows a schematic cross section through a fourth embodiment of a cathode according to the invention.

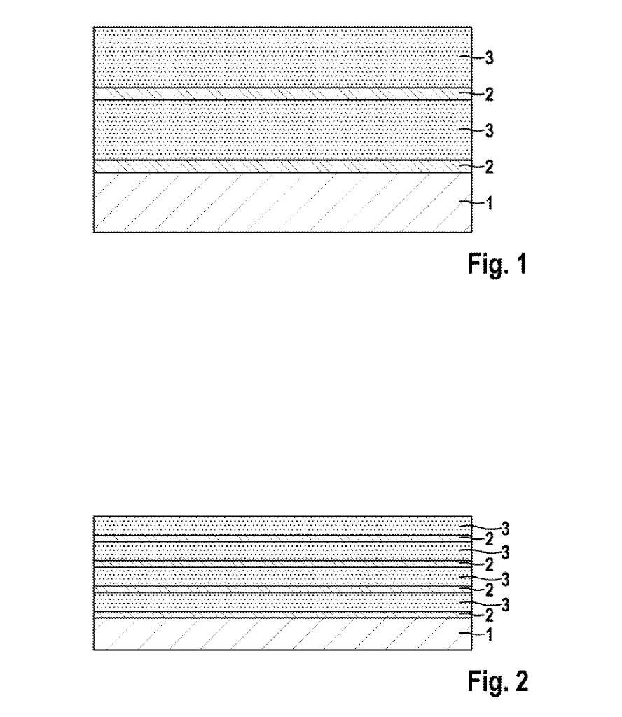

FIG. 1 shows that, according to this embodiment, the cathode has a current collector 1, to which a conductive layer 2 is applied, with a sulfur-containing layer 3 being applied to the conductive layer 2. A further conductive layer 2 is applied in turn to the sulfur-containing layer 3, with a further sulfur-containing layer 3 being applied in turn to said further conductive layer.

Here, the conductive layers 2 make electrical contact (not shown) with one another and also with the current collector 1. The electrical contact between the conductive layers 2 and also between the conductive layers 2 and the current collector 1 can be made in this case, for example, at the edge of the layer system. It is similarly possible, however, to provide electrically conductive portions in the sulfur-containing layers 3, said portions connecting the adjacent conductive layers 2 to one another in an electrically conductive manner.

The conductive layers 2 and sulfur-containing layers 3 differ here in their composition. The conductive layers 2 are formed at least substantially from an electrically conductive material, for example aluminum or, in particular bound, aluminum powder. The sulfur-containing layers 3 are formed substantially from a sulfur-containing material.

The application of thin conductive layers 2 advantageously makes it possible for a plurality of thin sulfur layers 3 to be applied without the proportion by weight of the electrically conductive material rising too greatly in relation to the active sulfur material.

The rate capability can advantageously be increased by virtue of the thin electrically conductive intermediate layers (conductive layers) 2. In addition, the thickness of the current collector 1 and also if appropriate the number of current collectors can be reduced on account of the conductive layers 2. This can advantageously lead to an increase in the energy density and to a reduction in weight.

In addition, a multilayered structure of this type makes it possible to produce regions in which the active material is present in a high concentration and diffusion thereof is inhibited. Furthermore, a multilayered structure of differing composition makes it possible that, in the regions which contain the active material, it is also possible to use compositions which exhibit high sulfur exploitation and a high capacitance, but which would be unsuitable as a sole coating material, for example owing to a low conductivity or poor adhesion properties.

The embodiment shown in FIG. 2 differs from the embodiment shown in FIG. 1 substantially in that the cathode layer system now has, instead of in each case two conductive layers 2 and sulfur-containing layers 3 in an alternating arrangement, in each case four conductive layers 2 and sulfur-containing layers 3 in an alternating arrangement.

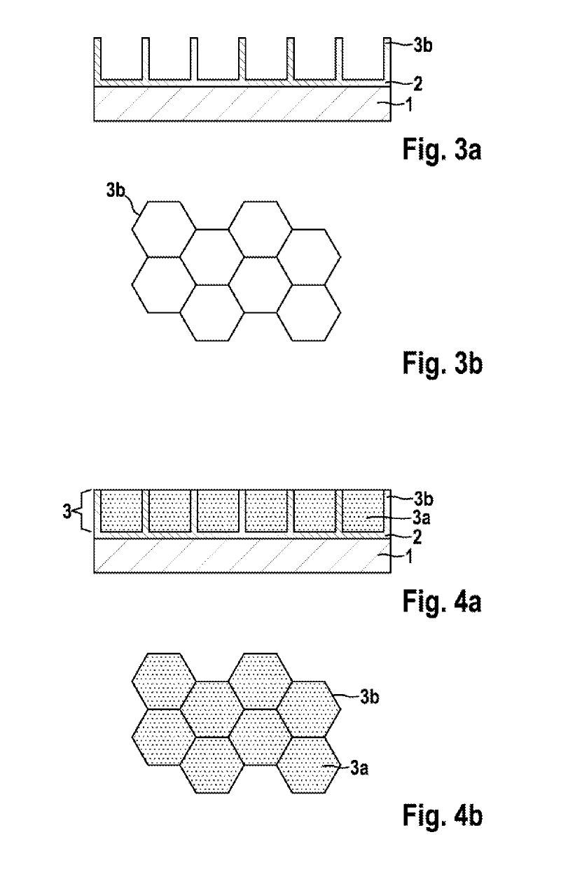

FIGS. 3a to 5 describe a method for producing a further embodiment of a cathode according to the invention which comprises structured, sulfur-containing layers 3.

FIG. 3a is a cross-sectional view and shows that firstly a conductive layer 2 has been applied to a current collector 1. An electrically conductive layer portion 3b of reticular form has in turn been applied to the conductive layer 2.

FIG. 3b is a plan view of the arrangement shown in FIG. 3a and shows that the electrically conductive layer portion 3b of reticular form has been configured in a honeycomb-like manner.

FIG. 4a is again a cross-sectional view and shows that the interstices of the electrically conductive layer portion 3b of reticular form have been filled with sulfur-containing material.

FIG. 4b is a plan view of the arrangement shown in FIG. 4a and shows that, as a result, a multiplicity of sulfur-containing layer portions 3a have been formed in the form of a repetitive pattern, in particular wherein the sulfur-containing layer portions 3a have been formed in each case in the internal spaces of the honeycomb.

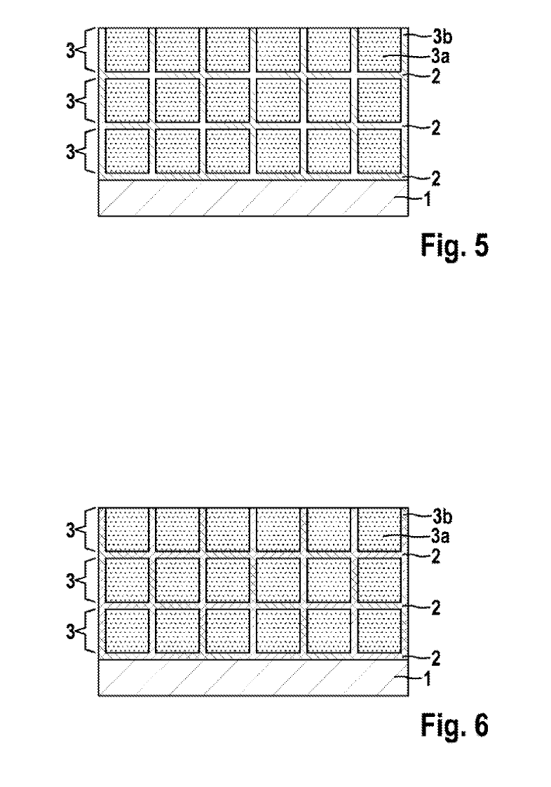

FIG. 5 shows that the repeated application of further conductive layers 2 and sulfur-containing layers 3, 3a, 3b structured in such a manner makes it possible to produce a complex cathode layer system in which the conductive layers 2 together with the electrically conductive layer portions 3b substantially enclose the sulfur-containing layer portions 3a.

FIG. 6 shows a further embodiment, this differing from the embodiment shown in FIG. 5 substantially in that the conductive layers 2 and electrically conductive layer portions 3b of the sulfur-containing layers 3 are formed from a porous material. In this way, transporting channels, through which ions, if appropriate together with electrolyte, can diffuse, can be produced in a targeted manner, and this can have an advantageous effect on the rate capability. This is advantageous particularly in the case of high layer thicknesses in order to provide that sufficient electrolyte quantities are always available, this having an advantageous effect on high current rates.

The porosity can also be generated by the local omission of electrically conductive material, for example by the use of masks or by the displacement of layers, shown by way of example in FIG. 4a, such that macroscopic hollow structures (holes, channels) are formed.

1. A cathode for a lithium-sulfur cell, comprising:
a current collector; and
a cathode layer system applied to the current collector, the cathode layer system including:
at least one conductive layer; and
at least one sulfur-containing layer,
wherein the at least one conductive layer is configured to make electrical contact with the current collector.

2. The cathode as claimed in claim 1, wherein the cathode layer system.

3. The cathode as claimed in claim 1, wherein the at least one conductive layer of the cathode layer system is applied to the current collector.

4. The cathode as claimed in claim 1, wherein:
the at least one sulfur-containing layer is structured and includes a multiplicity of sulfur-containing layer portions and at least one electrically conductive layer portion, and
each of the sulfur-containing layer portions is surrounded by the at least one electrically conductive layer portion.

5. The cathode as claimed in claim 4, wherein:
the sulfur-containing layer portions of the structured, sulfur-containing layer are configured in a repetitive pattern, and/or
the at least one electrically conductive layer portion of the structured, sulfur-containing layer has a reticular form.

6. The cathode as claimed in claim 4, wherein:
the at least one electrically conductive layer portion of the structured, sulfur-containing layer has a honeycomb-like form, and
each of the sulfur-containing layer portions of the structured, sulfur-containing layer is formed in internal spaces of the honeycomb-like form.

7. The cathode as claimed in claim 4, wherein the at least one structured, sulfur-containing layer is arranged between two conductive layers.

8. The cathode as claimed in claim 4, wherein at least one of the at least one conductive layer and the at least one electrically conductive layer portion of the structured, sulfur-containing layer is formed from a porous material or wherein at least one of the at least one conductive layer and the at least one electrically conductive layer portion of the structured, sulfur-containing layer has recesses which are introduced in a targeted manner.

9. The cathode as claimed in claim 1, wherein at least one of the at least one conductive layer and the at least one electrically conductive layer portion of the structured, sulfur-containing layer includes at least one of a metallic material and an electrically conductive material which conducts lithium ions.

10. A method for producing a cathode for a lithium-sulfur cell, comprising:
a) providing a current collector foil;
b) applying a conductive layer to the current collector foil; and
c) applying a sulfur-containing layer to the conductive layer.

11. The method as claimed in claim 10, further comprising:
d) applying a further conductive layer to the sulfur-containing layer.

12. The method as claimed in claim 10, wherein:
applying a sulfur-containing layer to the conductive layer includes applying a structured, sulfur-containing layer comprising a multiplicity of sulfur-containing layer portions and at least one electrically conductive layer portion, and
each of the sulfur-containing layer portions is at least substantially surrounded by the at least one electrically conductive layer portion.

13. The method as claimed in claim 11 or 12, wherein the conductive layer and sulfur-containing layer are applied by at least one of printing, doctor blade application, and spraying.

14. A lithium-sulfur cell, comprising:
a cathode, including:
a current collector; and
a cathode layer system applied to the current collector, the cathode layer system including:
at least one conductive layer; and
at least one sulfur-containing layer,
wherein the at least one conductive layer is configured to make electrical contact with the current collector.

15. The lithium-sulfur cell as claimed in claim 14, wherein the lithium-sulfur cell is included in a vehicle or energy storage installation.

16. The cathode as claimed in claim 2, wherein the conductive layers and sulfur-containing layers are formed in alternation.

17. The cathode as claimed in claim 7, wherein the two conductive layers cover the sulfur-containing layer portions.

18. The cathode as claimed in claim 7, wherein the sulfur-containing layer portions are enclosed by the conductive layers and the electrically conductive layer portions.

19. The method as claimed in claim 11, further comprising:
e) applying a further sulfur-containing layer to the further conductive layer.

20. The method as claimed in claim 12, wherein:
applying the sulfur-containing layer to the conductive layer includes applying the structured, sulfur-containing layer such that firstly at least one electrically conductive layer portion of reticular configuration is applied, the interstices of the electrically conductive layer portion of reticular configuration then being filled with sulfur-containing material.
